(19) United States
(12) Patent Application Publication
(10) Pub. No.: US 2014/0304614 A1
(43) Pub. Date: Oct. 9, 2014

(54) Plotting emails into a predetermined visual map

(71) Applicant: James McAlear, Ottawa (CA)

(72) Inventor: James McAlear, Ottawa (CA)

(21) Appl. No.: 14/111,968

(22) PCT Filed: Jun. 27, 2012
(86) PCT No.: PCT/CA2012/050430

§ 371 Date: Oct. 29, 2013

(30) Foreign Application Priority Data
Jul. 27, 2011 (CA) 2,747,549

(51) Int. Cl. H04L 12/58; G06F 3/0484

(52) U.S. Cl. CPC H04L 51/22; G06F 3/04842
USPC 715/752

(57) ABSTRACT

Coordinate information for an element of a project map comprises a user-selectable logistical indicator selected from a plurality of logistical indicators, each representing a different a manner of handling a project component and each uniquely represented by a predetermined visual indicium. The coordinate information, the map element and the logistical indicator are associated with electronic information. Using coordinate information provided by users, the map is displayed the predetermined visual indicia associated with the logistical indicators of the coordinate information plotted on the map elements. Each plotted visual indicium is selectable by a user to display at least a portion of the electronic information associated with the logistical indicator represented by that predetermined visual indicia. The result is to an electronic information management tool which provides a visual overview of the logistical indicators that have been selected by users for map components.

### FIELD OF THE INVENTION

This invention relates to the improved handling of emails and Internet content within personal and enterprise computing environments.

### BACKGROUND

Many people find email handling as frustrating as rush-hour traffic. To be sure, there are some emails that are easy to handle, for example near term tasks, calendar entries and chat from friends that are quickly and easily dispatched. But then there are other emails that are much less clear-cut, with those that relate to an unspecific future requirement or happening as being particularly vexing. The most common way of handling these emails at present is to file them into a choice of folders. But as emails continually accumulate in folders, people begin to lose a sense of what is contained in each folder. Search tools exist to help find emails that relate to a particular topic (if one can remember the existence of the original email)—but still, the larger synthesis view of what all the emails add up to within a folder is still missing.

### SUMMARY OF THE INVENTION

In accordance with an aspect of the invention, a product in the form of computer-readable media for electronic information management is provided. The computer-readable media product is configured for use with a computer program for processing electronic information; a computer program for displaying a diagram; and, a diagram store for storing diagram information, the diagram store comprising computer-readable storage media.

The computer-readable media product comprises computer program code executable by a computer for performing the following steps. Diagram information for a diagram is obtained from a user, the diagram being associated with a subject and comprising a plurality of inter-related diagram elements representing subject components, the diagram information configured for use by the computer program for displaying to display the diagram. The obtained diagram information is stored in the diagram store. Coordinate information for a diagram element of a diagram for which diagram information is stored in the diagram store is obtained from a user, the coordinate information comprising a user-selectable logistical indicator wherein the logistical indicator is selectable from a plurality of logistical indicators each representing a different a manner of handling the subject component represented by the diagram element and each uniquely represented by a predetermined visual indicium, and wherein the coordinate information, the diagram element and the logistical indicator are associated with electronic information by the user using the computer program for processing electronic information and stored in a store of electronic information accessible to the computer program of the computer-readable media. The coordinate information is stored in a store of coordinate information. Diagram information for a user-selectable diagram is obtained from the store of diagram information. Coordinate information associated with the diagram elements of the obtained diagram is obtained from the store of coordinate information.

The obtained diagram information, the obtained coordinate information and the computer program application for displaying are used to display the user-selected diagram, wherein the displayed user-selected diagram has plotted on it, in association with the diagram element(s) of the obtained coordinate information, the predetermined visual indicium(ia) associated with the logistical indicator(s) of the obtained coordinate information. The resulting displayed user-selected diagram with plotted predetermined visual indicium(ia) provides a visual overview of the logistical indicators that have been selected by users and stored in the store of coordinate information for the displayed user-selected diagram.

The plotted predetermined visual indicium may be selectable by the user to display or retrieve at least a portion of the electronic information associated with the logistical indicator represented by that predetermined visual indicium.

The diagrams may, for example, be flow charts, maps, charts, tables or project plan. The predetermined visual indicia may be graphic elements, each predetermined visual indicium being a different graphic element from the other predetermined visual indicia. Alternatively, for applications in which the displayed diagram has a relatively substantial storage of coordinate information, the predetermined visual indicia may be colours, each predetermined visual indicium being a different colour from other predetermined visual indicia, whereby the plotting of the predetermined visual indicium(ia) is in the form of a bar chart wherein like colours are grouped together and colours are arranged as a continuum of colour.

The computer program for processing electronic information may be an electronic mail program, with the electronic information being at least a portion of an item of electronic mail. The computer program for displaying a diagram may be a web browser program.

In accordance with a further aspect of the invention, the computer-readable media product is configured for use in a computer network comprising at least one server computer, a plurality of user computers and the stores of diagram information, coordinate information and electronic information. At least a portion of the computer program code is executable by each user computer for performing the following steps: (i) obtaining from a user and providing to the server computer the obtained diagram information; (ii) obtaining from a user and providing to the server computer the obtained coordinate information; (iii) using the computer program application for displaying to display the user-selected diagram with the plotted predetermined visual indicium(ia) and to display the at least a portion of the electronic information associated with the logistical indicator represented by the plotted predetermined visual indicium(ia); and, (iv) using the computer program application for processing electronic information to process the electronic information and provide the processed electronic information to the server computer. And, at least a portion of the computer program code is executable by the server computer for: (v) obtaining the diagram information from a user computer; (vi) obtaining the coordinate information and the electronic information associated with the coordinate information from a user computer; and, (vii) storing in and retrieving from the stores of diagram information, coordinate information and electronic information the obtained diagram information, coordinate information and electronic information, respectively.

Preferably, the at least a portion of the computer program code is executable by each user computer for obtaining from a user in addition to the diagram information user profile information and for providing the user profile information to the server computer, the user profile information defining one or more limitations on user contributions to the coordinate information for the diagram. And, preferably, at least a portion of the computer program code is executable by the server computer for obtaining the user profile information from the user computer and for storing in and retrieving from a store of user profile information the user profile information for the diagram. The obtaining of coordinate information for a diagram from users is preferably controlled according to the user profile information for the diagram. The user profile information is preferably used to control the use of coordinate information in displaying the user-selected diagram.

In an exemplary embodiment of the invention, at least a portion of the computer program code is executable by the server computer for: (i) using the obtained diagram information, user profile information and coordinate information for defining for a user computer, for a user-selected diagram, plotted diagram information for the plotting of the predetermined visual indicium(ia) on the user-selected diagram; and, (ii) providing the plotted diagram information to the user computer.

In accordance with another aspect of the invention there is provided a method for use by a computer for electronic information management, the method including the following steps. Diagram information for a diagram is obtained from a user of the computer, the diagram being associated with a subject and comprising a plurality of inter-related diagram elements representing subject components, the diagram information configured for use to display the diagram. The obtained diagram information is stored in a store of diagram information. Coordinate information for a diagram element of a diagram for which diagram information is stored in the diagram store is obtaining from a user of the computer, the coordinate information comprising a user-selectable logistical indicator wherein the logistical indicator is selectable from a plurality of logistical indicators each representing a different a manner of handling the subject component represented by the diagram element and each uniquely represented by a predetermined visual indicium, and wherein the coordinate information, the diagram element and the logistical indicator are associated with information accessible to the computer. The coordinate information is stored in a store of coordinate information. Diagram information for a user-selectable diagram is obtaining from the store of diagram information and coordinate information associated with the diagram elements of the obtained diagram is obtaining from the store of coordinate information.

The obtained diagram information and coordinate information are used to display the user-selected diagram with the predetermined visual indicium(ia) associated with the logistical indicator(s) of the obtained coordinate information plotted on the displayed diagram in association with the diagram element(s) of the obtained coordinate information. The displayed user-selected diagram with plotted predetermined visual indicium(ia) provides a visual overview of the logistical indicators that have been selected by users and stored in the store of coordinate information for the displayed user-selected diagram.

A further embodiment of the method may be used by computers of a computer network comprising at least one server computer and a plurality of user computers, the computer network including the stores of diagram information, coordinate information and electronic information. User computers obtain from a user and provide to the server computer the obtained diagram information; obtain from a user and provide to the server computer the obtained coordinate information; display the user-selected diagram with the plotted predetermined visual indicium(ia) and the at least a portion of the electronic information associated with the logistical indicator represented by the plotted predetermined visual indicium(ia); and, process the electronic information and provide the processed electronic information to the server computer.

The server computer obtains the diagram information from a user computer; obtains the coordinate information and the electronic information associated with the coordinate information from a user computer; and, stores in and retrieves from the stores of diagram information, coordinate information and electronic information the obtained diagram information, coordinate information and electronic information, respectively. Each user computer may obtain from a user in addition to the diagram information user profile information and provide the user profile information to the server computer, the user profile information defining one or more limitations on user contributions to the coordinate information for the diagram, and whereby the server computer obtains the user profile information from the user computer and stores in and retrieves from a store of user profile information the user profile information for the diagram.

### BRIEF DESCRIPTION OF THE DRAWINGS

A preferred embodiment of the invention is described in detail below with reference to the following drawings in which like references pertain to like components throughout:

FIG. 1 illustrates a diagram pertaining to the subject conference room rebuild, in the form of a project map, created by a user of the invention whose responsibility center is department 6K63;

FIG. 2 illustrates electronic information in the form of an item of electronic mail, and two items of coordinate information provided by the user Elmer Employee for a diagram element “Ideas for IT equipment” of the diagram of FIG. 1;

FIG. 3 illustrates particulars of coordinate information obtained from the user Elmer Employee for one of the items of coordinate information shown in FIG. 2;

FIG. 4 is a block diagram of the system architecture of a computer-readable media product in accordance with the invention;

FIG. 5 illustrates electronic information in the form of another item of electronic mail, and an item of coordinate information provided by the user Peter Peon in response to the coordinate information shown in FIG. 2 provided by Elmer Employee;

FIG. 6 illustrates a chart showing exemplary limitations defined by user profile information for diagram elements of the diagram shown in FIG. 1, for controlling user contributions of coordinate information and electronic information therefore;

FIG. 7 illustrates a chart showing exemplary limitations defined by user profile information for diagram elements of the diagram shown in FIG. 1, for controlling the use of coordinate information in displaying a user-selected diagram;

FIG. 8 is a listing, on the left hand side, of exemplary predetermined visual indicia representing user-selectable logistical indicators for the coordination information provided for the diagram of FIG. 1 and, on the right hand side, of the exemplary user-selectable logistical indicators corresponding thereto;

FIGS. 9 (a) to (c) illustrates exemplary alternate predetermined visual indicia representing user-selectable logistical indicators for the coordination information;

FIG. 10 illustrates particulars of coordinate information obtained from the user Peter Peon for the coordinate information shown in FIG. 5; and,

FIG. 11 illustrates the diagram of FIG. 1 having the predetermined visual indicium for the logistical indicator of the coordinate information of FIG. 3 plotted on a diagram element thereof.

### DESCRIPTION OF A PREFERRED EMBODIMENT

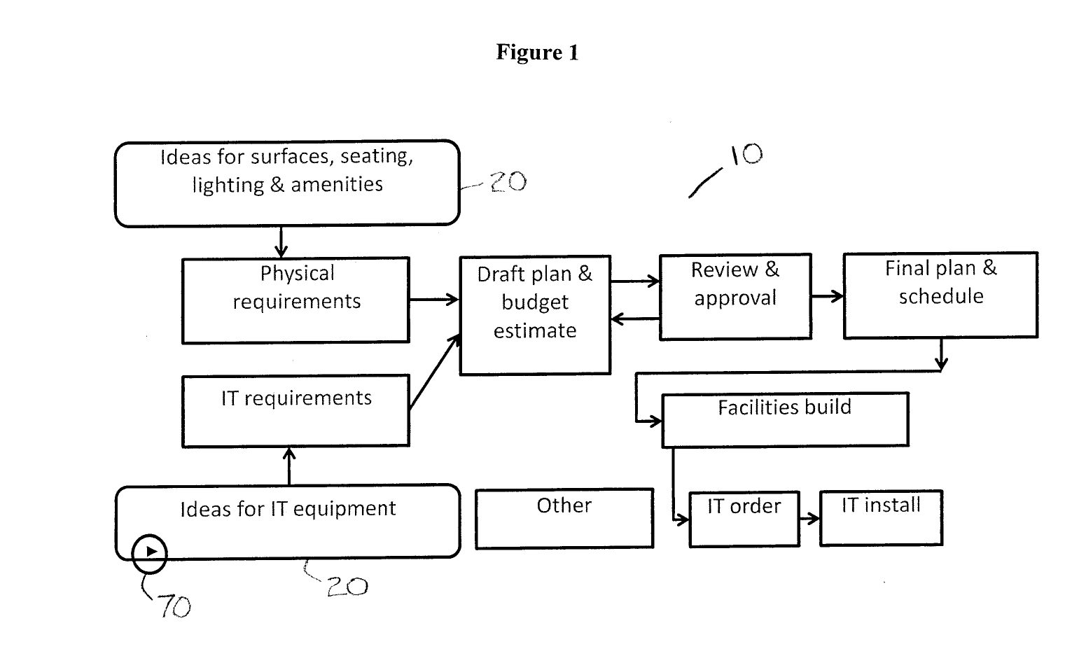

An objective of the invention is to allow electronic information to be processed (e.g. the composition of emails) in a manner to contribute a particular logistical indicator for the manner of handling a component of a project plan, and then to use the contributed logistical indicators to display a visual synthesis of the project plan and contributions whereby the electronic information and logistical indicator therefor provided by each contributor is rendered as a compact predetermined visual indicium. To this end, a preferred embodiment of the invention, as illustrated by FIGS. 1-11, provides for an item of electronic mail (i.e. an email) to contain coordinate information that will allow it to be plotted against a diagram in the form of a map. The plotted map provides a user with a visual synthesis of user contributions to elements of the map which is useful for the handling and management of the electronic information contributed to the project to which the map pertains.

In the embodiment illustrated by FIGS. 1-11, the diagram 10 is a map pertaining to a subject which is a project for the rebuild of a conference room. In alternative embodiments the diagram may be a plan, process diagram, flow chart or other form of chart or table used for describing, planning for and/or arranging a subject or achieving a particular objective for a subject.

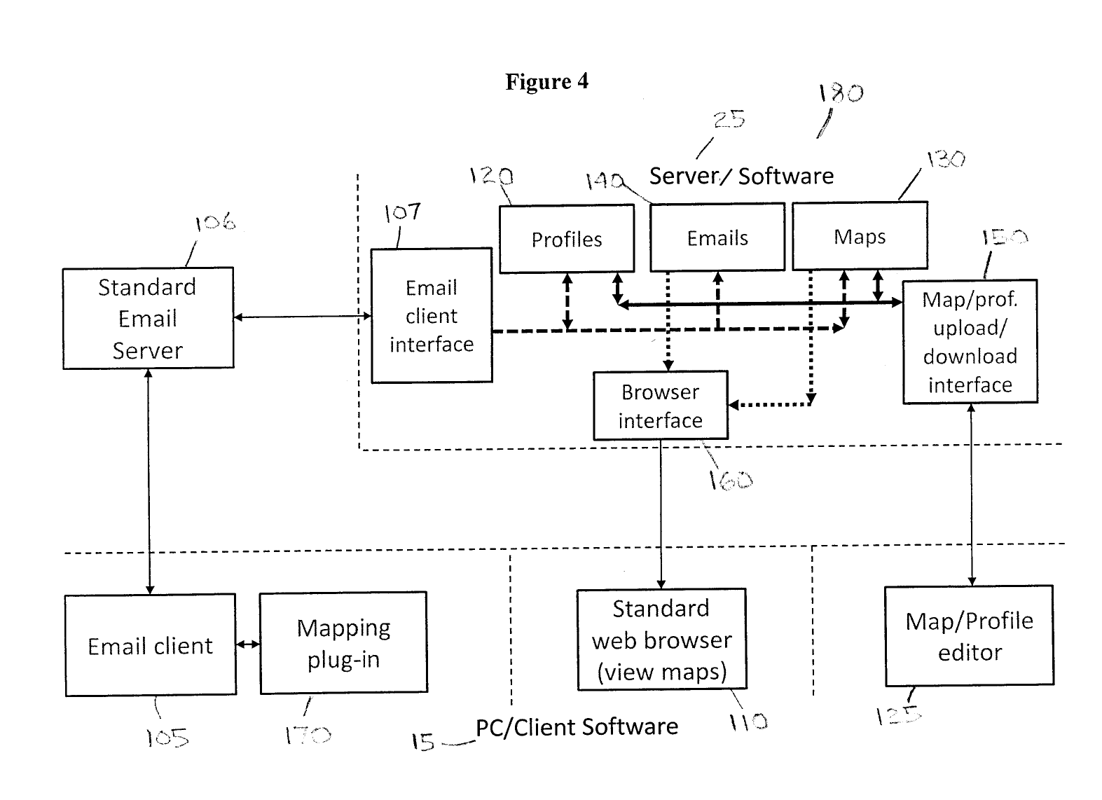

As shown by FIG. 1, the diagram (map) 10 comprises a plurality of inter-related diagram elements 20 representing subject components. The map 10 is defined by diagram information configured for use by a computer program for displaying, in this embodiment being a web browser program 110 (see FIG. 4), to display the map 10. Coordinate information 50 references a specific map 10 and a diagram element 20 of the map. The plotting of the predetermined visual indicia 70, being graphic elements in the illustrated embodiment, on the map 10 involves rendering of the graphic elements 70 for logistical indicators 60 of coordinate information 50 for electronic information 30, being emails in the illustrated embodiment, contributed by users. The specific graphic element 70 predetermined for a particular logistical indicator 60 is selected to reflect the logistic nature of user's contributed designation for the manner of handling the electronic information 30 in relation to the project.

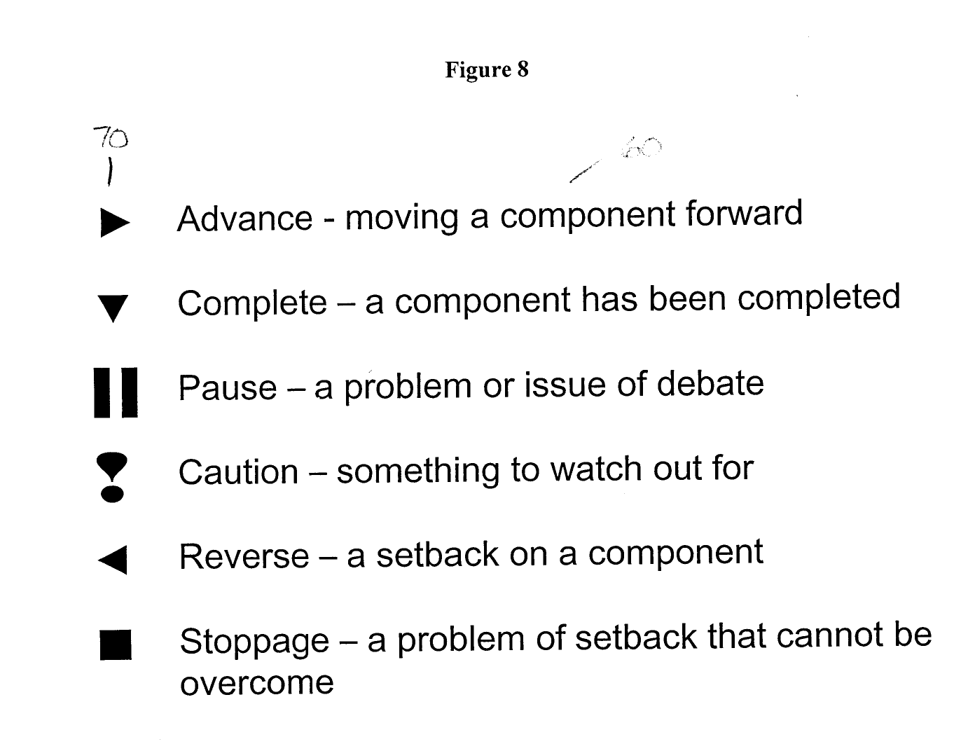

For example, FIG. 8 illustrates a set of visual indicia and the logistical indicators they represent for the preferred embodiment, in which the logistic indicator may reflect that the email captures one of the following logistics for handling a referenced diagram element: advance, complete, pause, caution, reverse or stop (many of these graphic elements are commonly used with DVD/media controls).

As emails and plotting accumulate, a user can see from a display of the plotted diagram which components of the project are most and least actively contributed to by users, as well as obtain a visual measure of the manner of the handling that is happening for each subject component. This capability serves to assist a user to overcome any feeling that their email folders are nebulous dumping grounds. In addition, it will drive contributing users to send emails with greater clarity by making them think through what project component they are specifically addressing and what kind of handling or progress they are proposing. In summary, having such clear information structures in place should lead to people creating less nebulous emails overall.

In addition, one of the benefits of email is its potential to allow collaboration amongst a group, though again there can be a lot of frustration that ensues from over-use of reply-to-all and other nebulous discussions that occur. The computer-readable media product and method of this invention will also serve to introduce a layer of crispness to such collaborative discussions to arrive at a more clearly defined resolution.

The details of the invention are best understood by following the steps performed in respect of an exemplary item of electronic information in the form an email. Consider an email from an employee (being Elmer Employee in the figures), who recently attended a trade show where the employee observed an impressive demonstration of a particular piece of conferencing equipment. As indicated by the map of FIG. 1, the employee's department's meeting room and facilities are to be renovated in the upcoming fiscal year. This is the kind of email that would be dumped by the user into some quickly chosen folder because the information might be useful later for the renovation project, but exactly when it will be needed is hard to judge. Then, as other related emails pile up, the information in this particular one may never be accessed due to information overload and numbness to the email stack over time.

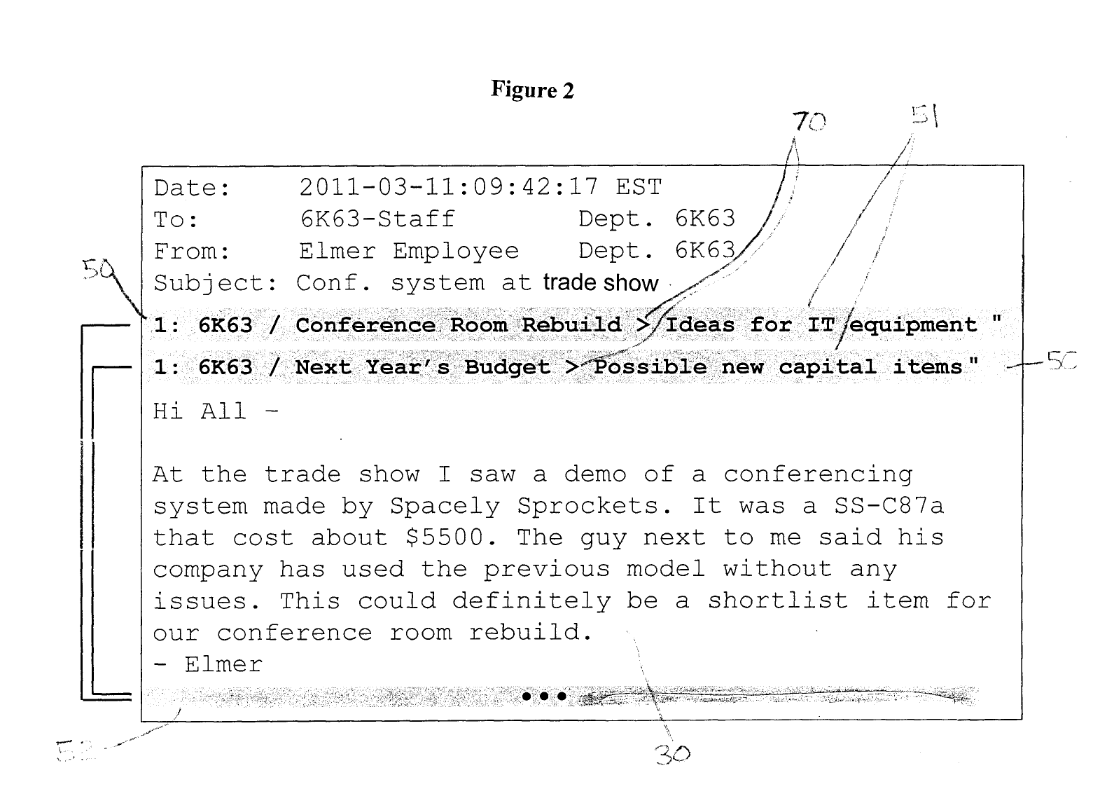

This changes, however, when there is a project map according to the invention available to the user to which this email might be posted, as shown in FIG. 1. From FIG. 1, it can be seen that this email would contribute as a logistic “advance” (per the predetermined visual indicia 70) against the subject component “Ideas for IT equipment” of a diagram element 20. The invention allows the author of this email to insert strips of coordinate information 50 into the email as illustrated in FIG. 2. In this particular case, since the email also includes some potential budgeting details, a separate strip of coordinate information 50 is included to also post this email against a budgeting map (not shown). In FIG. 2, the strips appear as graphic elements; but as an alternative, for example, a strip could comprise of an observable set of structured text such as being enclosed in a unique mark-up notation such as {|1:6k63 . . . |} such that it can be reliably identified within the surrounding email text.

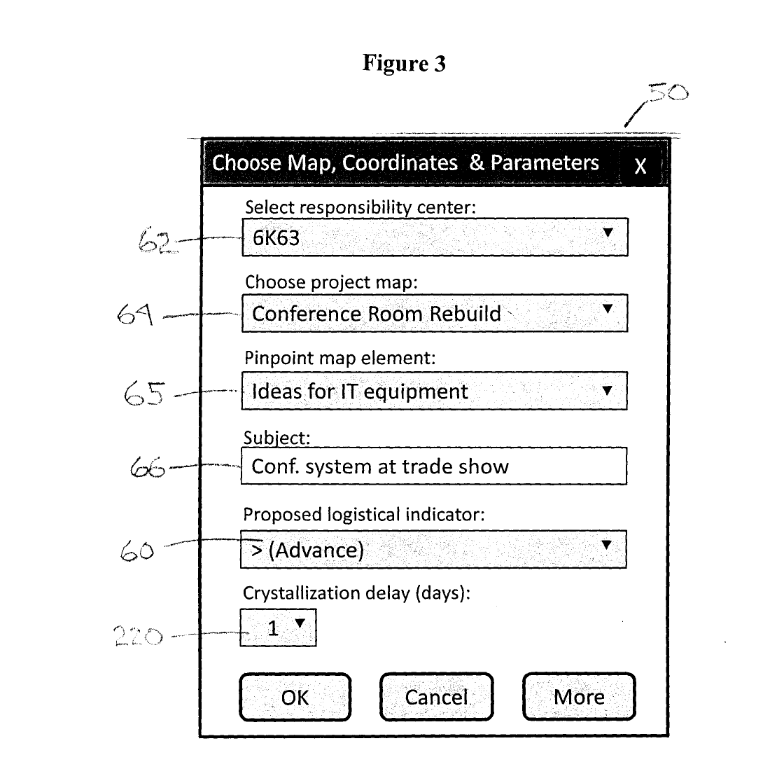

The coordinate information 50 contains a number of separate fields which invoke a particular functionality. One of these fields is a crystallization delay. In the example of coordinate information shown by FIG. 3 this field is set to 1 day, which indicates that a team member can intercede in respect of the potential posting within 1 day to cancel or alter the posting, subject to governing user profile controls and, otherwise, it will be posted 1 day after it has been submitted for plotting onto the map. The function of this crystallization delay is described in greater detail below.

Another field of the coordinate information 50 specifies the source, e.g. author or department within the organization that the specified map belongs to (it is to be noted that many departments within an enterprise may have budget and renovation maps operating in parallel) which, in this example, is the department is “6K63”.

Another field is for a user-selectable logistical indicator having a representative predetermined visual indicium. In this example, the logistical indicator is selected to be “Advance” and its representative visual indicium is the “>” graphic element. This selection is intended to mean that the user contributes this email to advance the project component “Ideas for IT equipment”. Alternatives that may be selectable include the “<” graphic element to represent a reverse, the “>|” graphic element to represent a completion, and others, as desired for the particular embodiment.

Another field identifies the particular diagram element that the email pertains to which, in this case, is the map element for the subject component “Ideas for IT equipment”. And another field is used to capture some explanatory text for the posting. In this case, the double quote punctuation shown in the strip of coordinate information of FIG. 2 means that the user has opted out of supplying specific text and the email subject line should be used by default.

In the illustrated embodiment, the computer-readable media product and method of the invention are used in a computer network having a system architecture as illustrated by FIG. 4. A user computer 15 is one of a plurality of user computers in a computer network which also includes a server computer 25 and stores of diagram information, electronic information, coordinate information and user profile information. It will be understood by the skilled reader that these information stores are provided by one or more computer storage means in the form of storage media. User computers use a computer program for processing electronic information, in this example being email client software 105, and also a computer program for displaying a diagram which, in this example, is a web browser 110.

The computer-readable media product of the invention includes a plug-in application 170 which operates with the email client software 105 to provide a user menu to the user which allows the user to compose the coordinate information without making typing mistakes or having to rely on memory or otherwise searching collateral project information in order to create a proper strip of coordinate information. In this network implementation portions of the computer program code of the computer-readable media of the invention are executed by the user computers 15 and portions are executed by the mapping server computer 25. However, in a single computer implementation, the computer program may be executable by the single computer.

FIG. 3 shows a conventional looking pull-down menu form that aid's the user in such composition. This is accessed as a menu command or a tool-strip button in the email client software application, but an alternatively configuration could be chosen for another embodiment, as desired. For example, it could operate as a separate tool that puts a string of marked-up text into the system clipboard to allow it to be pasted into any email. The plug-in application 170 uses the specific computer and network resources to obtain a listing of the various maps that the user may contribute to and offers appropriate selection menus as the user works down the menu form. By default, a user will normally see the user's own department at the top, but if the user intends to submit something to another department that the user has permission to contribute to, the user will select that department from a top menu selection 62. Once the department level is selected, the maps for that department which are available to that user, based on the controls of the user profile information, are listed in a second menu selection 64.

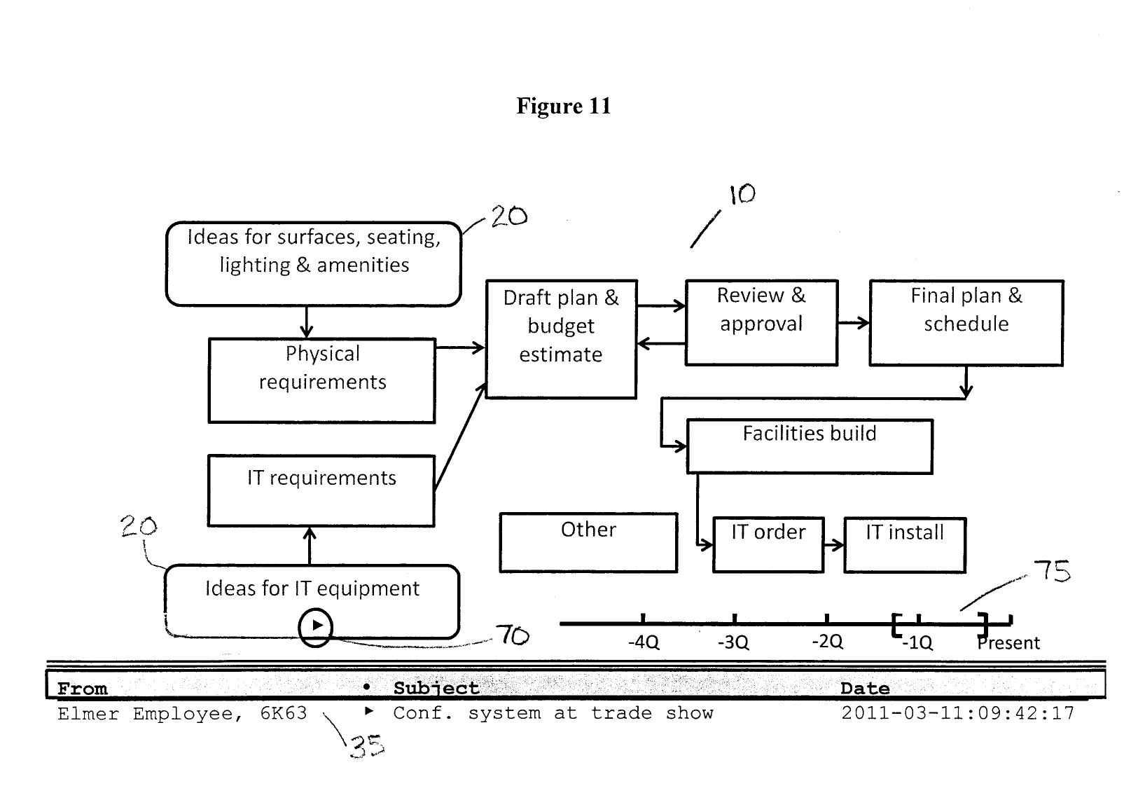

Once the map has been selected, then another menu selection 65 is automatically populated by the embodiment of the invention with the available diagram elements to which the user may contribute, based on the controls of the user profile information, by posting the user's email. The explanatory text box (field) 66 is automatically filled with the subject line of the email, but an option is provided to the user to edit this field to provide greater specificity if desired. As shown by FIG. 11, such text is optionally used by the embodiment of the invention to provide a visual “pop-up” message 35 when a user hovers over the particular graphic element plotted on the map when the map is displayed following the posting of the coordinate information for the email. The user menu further provides choices to the user for selection of a logistical indicator 60 and the crystallization delay parameter 220. Once these fields are in a satisfactory state the user may click “OK” and have the strip of coordinate information associated with the email (or “Cancel” otherwise).

It is possible that an email could contain a number of different items that relate to different diagram elements of possibly different maps. To allow this to be captured, the preferred method of the embodiment of the invention is to permit opening and closing boundaries 51, 52 to be designated by the user. If desired, an alternative to the closing boundary 52 of FIG. 2 could instead be provided as a separate tool bar control or menu command or be inserted as marked-up text such as “{∥}”. Thus, all of the email content between an opening boundary and the next closing boundary would be associated with the specified opening strip of coordinate information. If there is no closing strip after an opening strip, then all the remaining email content is associated with the opening strip coordinates subject to any controls to be applied. Accordingly, specific sections of an email could be plotted on the same or different maps (diagrams) and/or diagram elements depending upon the opening and closing boundaries designated by the user.

In a more elaborate implementation, consistent with today's level of expected user controls and features for working with information, the user map display of FIG. 1 may be enhanced with various controls and accessory information panes to provide a richer view of the accumulated information. Controls may be provided that allow for the filtering of which emails are rendered on the map by plotted visual indicia, such as restricting them to a specified time frame 75 as shown in the map display of FIG. 11, or from a user-selected set or group of users, or from other available data fields provided to the user. In addition, an option may be provided to a user to interact with a displayed map to select a certain diagram element (subject component), and have all the contributing emails to that subject component be listed in a separate view pane so that the user can dig further into one or more such email. The implementation of such options, controls and view-panes will be understood by a skilled reader and is similar to those used in the current generation of sophisticated email clients.

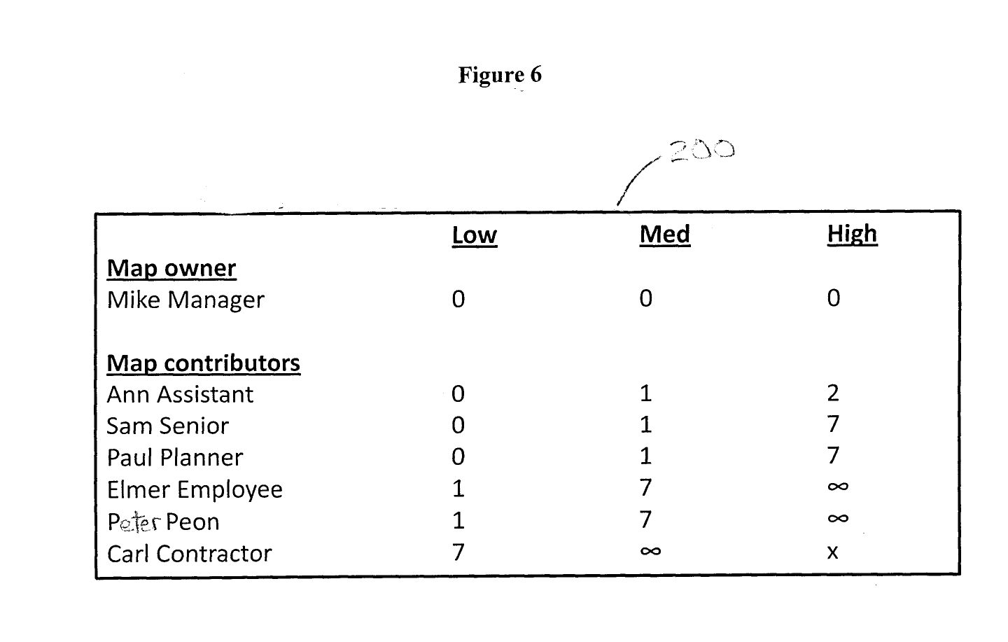

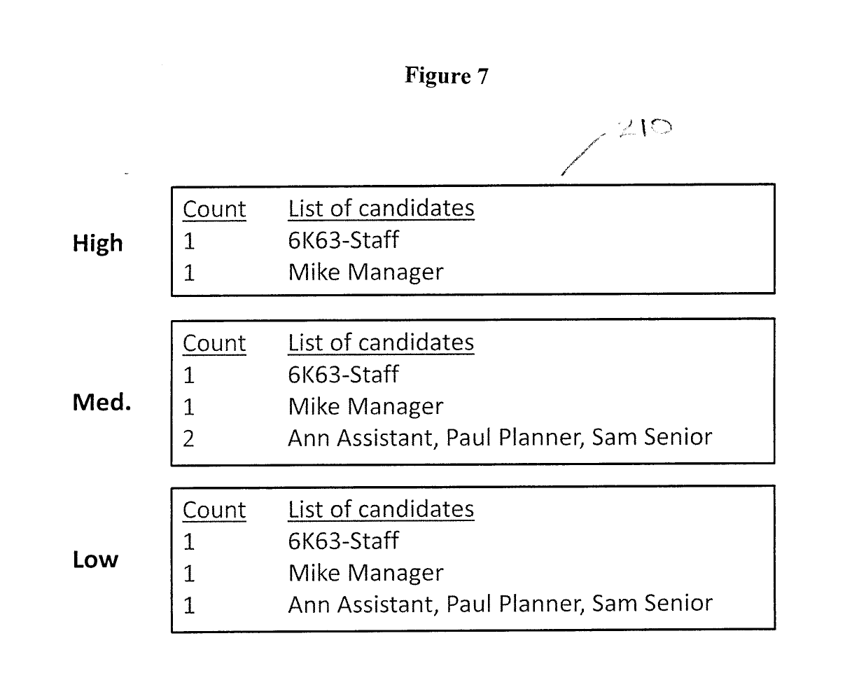

The embodiment of the invention obtains and configures the information provided by users that is needed to render the visual overview displays provided by the invention, such as the plotted diagram shown by FIG. 11. It also optionally obtains and configures the aforementioned collaboration controls shown by FIG. 7 and the crystallization delay controls shown by FIG. 6. For ease of description, the computer-readable media product and method are illustrated in a system architecture as shown by FIG. 4, which includes three main blocks: a conventional email user client implemented on a user computer (e.g. a personal computer) 105 with a plug-in application 170 of the invention, a conventional email server 106, and a new mapping application of the invention 180 on a server computer 25.

Once a user has constructed coordination information for an email this information is transferred to the server 25 for later assembly into a displayed plotted diagram. The preferred method of transfer is to assign the mapping application 180 its own account on the email server 106, and in this way, the email ID of the mapping application can be simply addressed for transfer by the email application by including it as an addressee using the standard email “CC” or “BCC” fields. This provides an advantage of overall compatibility with current email applications and avoids any requirement for a separate connection or transfer from a user client to the mapping server in order to send email content. This is especially useful considering that emails are often sent remotely via small handheld devices using mobile phone networks, and this transfer method avoids any extra bandwidth charges or the complication of requiring new application ports through an enterprise firewall. The email plug-in 170 which enables a user to easily compose the strips of coordinate information also, preferably, automatically includes the mapping server email address in the “CC” or “BCC” address fields without the need for any user intervention.

As illustrated by the system architecture of FIG. 4, one of the three functions of the mapping server 180 is to obtain coordinate information from the email client 105 via the email server 106 and to send updated diagram (map) metadata when a diagram is updated and updated coordinate information to the email client plug-in so its data is updated and the menus provided for constructing a strip of coordinate information provided in the menu dialog boxes is correct. Thus, limited map metadata is sent out as an attachment to the email clients and is used by the plug-ins to remain in proper synch.

The web browser 110 residing on a user computer 15 is able to communicate with the map server 180 to browse for different maps and have these rendered appropriately on the screen. The sophisticated filtering controls and viewing panes can be implemented with conventional web capabilities such as JavaScript and other comparable technologies. A web browser is the preferred method of access due to its general availability across so many client platforms and the fact that the map rendering and complementary controls are an easy fit into conventional web browser capabilities.

The computer-readable media product of the invention also includes computer program code executable by a user computer 15 to produce (i.e. draw) diagrams (maps) and this is illustrated in FIG. 4 as a map/profile editor 125. The functions of this portion of the computer program code will be familiar to a skilled reader and are similar to those contained in many common computer drawing programs such as Microsoft's PowerPoint product, but an important difference is that the diagram information defining not only the basic diagram but also some of the same metadata used for coordinate information, and also user profile information provided by a user for elements of the diagram.

An interface 150 of the server computer 25 uploads and downloads diagram and user profile information to the map server 180. Such upload/download interfaces are standard offering on client and server computers and are typically accomplished with HTTP or FTP.

Items of metadata include the designation of a specific department for each map as well as a unique title for a given map within a department. The metadata also includes the specific labels for the subject components of the diagram elements that can be referenced within a strip of coordinate information. For example, in FIG. 1 the diagram element 20 which includes the visual indicium representing the advance logistical indicator, the label “Ideas for IT equipment” is provided by a user in the metadata of the diagram information. This metadata is then exported by the map server 180 to the email client plug-ins 170 of user computers 15 as a specific and recognizable file attachment, to enable the ease of coordinate information strip composition described above.

Additional metadata is also obtained and stored by the computer-readable media product for each diagram element of the diagram, defining its placement and size, for use in displaying a user-selectable diagram with its associated visual indicia plotted (i.e. overlayed) on the associate diagram elements of the displayed diagram. Preferentially, the positions and sizes of text within a diagram element are configured in a way that leaves some margin room at the bottom of a diagram element where the visual indicia are rendered (plotted) without obscuring the component labels.

As mentioned, the email server 106 is a fully conventional one and the only additional requirement is for the administrator of the email server to set up a specific ID for use by the map server 180.

The map server 180 communicates with the email server 106 to receive emails (electronic information) with coordinate information 50 and to send out updated metadata as needed. The map server 180 also functions as a conventional web server to provide plotted diagrams (maps) to a user computer when a user selects a diagram for display on a display of the user computer. In addition, the map server 180 downloads and accepts uploads of drawn maps and user profile information containing collaboration setting controls. The map server application 180 has access to a store of the email and coordination information 140, the diagram information 130 and the user profile information 130.

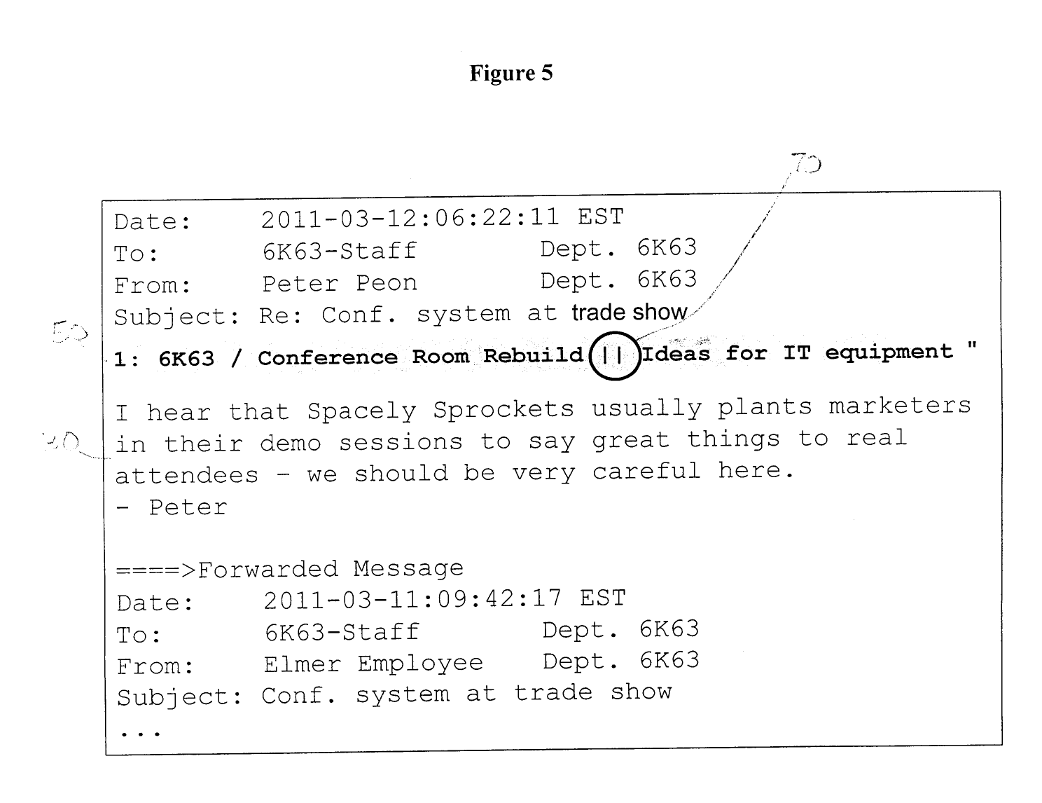

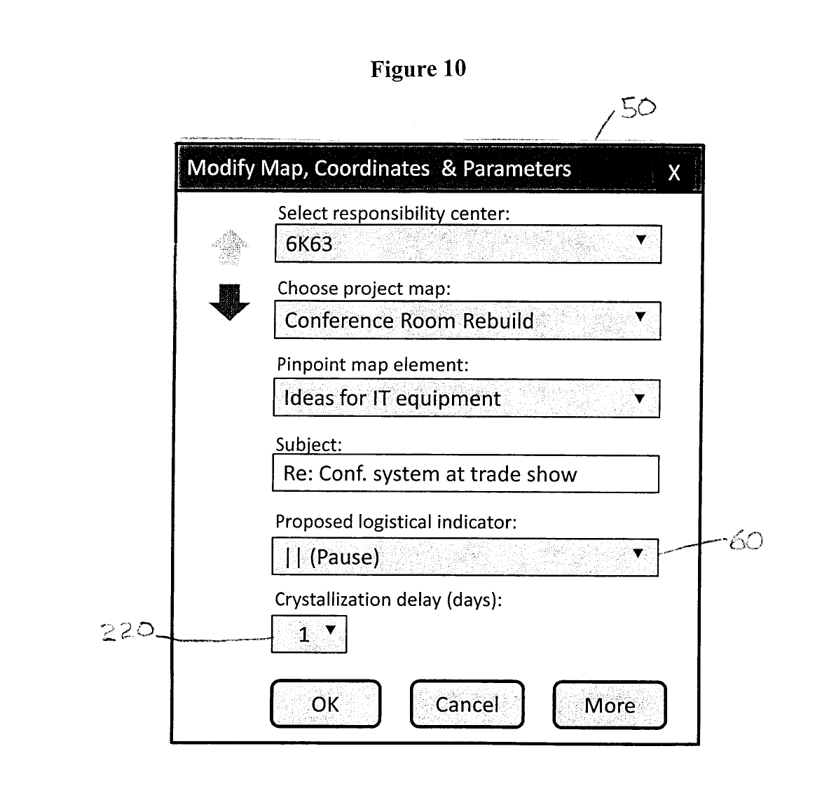

The collaboration features and the crystallization delay function are described with reference to FIGS. 5 to 7. As a specific example, FIG. 5 illustrates a reply to an original email of FIG. 2 (see also FIG. 10 which illustrates particulars of coordinate information obtained from the user for the coordinate information shown in FIG. 5). This reply demonstrates the potential collaboration benefit of an email system, in that the author of the reply is able to offer additional useful information relating to the original email for handling the subject matter of ideas for IT equipment. In this example, the coordination information strip of the original email is to be regarded as only a proposed contribution to a map, and not necessarily a final contribution. This is because in order to be crystallized to final status, for purposes of the diagram plotting of the invention, it must pass the applicable collaboration and crystallization delay controls which are designed to allow other users to provide additional information that might better capture the nature of the proposed information or to cancel or exclude the proposal altogether.

In the coordinate information of the original email the crystallization delay value of 1 day means that unless another user receiving the email were to respond (contribute) within the 1 day time period, then by default the information in the coordinate strip would be crystallized by the computer-readable product and would, therefore, be plotted on the diagram when displayed by a user. However, FIG. 5 presents a counter-proposal that this information should instead be represented by a “pause” logistical indicator, and this counter-proposal also has a crystallization delay of 1 additional day for further counter-proposals.

Distribution controls are provided to allow, for example, a manager of a team to control how users are able to contribute to these maps, folding in factors of relative process importance and skills and experience of different people on a team. FIG. 6 shows a table of settings that control crystallization parameters for different project types and different team members. The different project types shown here have three different levels of significance for proposing a contribution, ranging from low, where there are few constraints for people to contribute, to medium and high which require more and more experienced people providing oversight. Different maps, or different diagram elements within maps, may be assigned a specific level of significance, as user profile information, to control user contributions and oversight. This user profile metadata would also be distributed to email clients along with the other types of metadata discussed above.

FIG. 6 is a chart showing limitations defined by user profile information for diagram elements of the diagram shown in FIG. 1. Three general groups that have different permissions which serve to control user contributions of coordinate information and electronic information. The manager can make a contribution anytime to any level map without any delay (but he/she could still offer a longer number in any given email). Senior employees will generally be given shorter minimum delays than junior employees; further more sensitive projects will have higher delays than less sensitive ones. Finally, some employees, for example contractors, may be blocked from proposing content to certain maps (indicated with an “x”), and some, typically junior employees, may be blocked from having a contribution ever being automatically posted to a project (marked with the infinity symbol). Thus, a blocked employee would need to have another, typically a senior employee, reply to a proposal of the blocked employee, with a suitable coordinate information strip, in order for the proposal to result in an approved (crystallized) contribution.

In another aspect concerning collaboration parameters of projects, a manager may wish to institute different levels of collective oversight for different levels of project sensitivity, as shown by the crystallization minimum distribution list profiles set out in the table of FIG. 7. In order for a user contribution (email contribution) to crystallize, it must meet one of the minimum distribution counts set by the governing controls defined by the crystallization profile assigned to it. According to the controls described by the FIG. 7, a minimum requirement for making a contribution against any level of map is to copy the entire department or the manager on the email. But for lower levels of sensitivity, other options are available. For a medium sensitivity project, a team member could alternatively copy just two senior employees to propose a contribution. For the lowest level, copying just one senior employee would also suffice. The user profile information contained in these collaboration parameter tables are configured by a user such as the manager of a given responsibility center, using the map/profile editor 125 and uploaded to the map server 180 for use to control the contributions to, and plotting of, map elements of displayed diagrams.

Typically, on setting up the computer-readable media product of the invention a manager of a responsibility center is configured as a user having access to the map server 180. The manager/user is able to author a new diagram, for example a project plan map, and provide user profile information including collaboration parameters for the diagram elements. Normally, the information will indicate whether the constraints are high, medium or low for the map or for diagram elements of the map. A diagram or diagram element may require that all user contribution proposals must be approved by one or more designated users (e.g. manager) in order for them to crystallize. Further, contribution controls may enable one or more designated users (e.g. manager and a senior employee) to cancel a proposal to prevent it from being crystallized (e.g. if judged as being not significant enough a contribution).

The user/manager is further able to set-up and maintain (update) the collaboration tables to set the crystallization delays and oversight parameters for the three levels of projects. All this information is uploaded to the map server 180. The map server extracts the metadata for the maps and collaboration parameters for each person (as identified by an email address) of the user profile information and assemble these into an attachment that is then emailed to each user and used to update the user plug-ins. The user can access the specific attachment to be used as settings in the email plug-in 170. At this point the user can use the computer-readable media product, within computer network of the illustrated system architecture, to compose emails with coordinate information strips that contain the applicable metadata and adhere to the required collaboration controls set by the user profile information. Other users can also reply to these. As these emails are sent, the map server regularly receives these and stores the provided information into one or more of the stores 120, 130 and 140, unless they do not conform to the pre-set collaboration parameters, whereby they might be dropped/ignored, or the deviant email might be bounced back to the offending contributor.

Further, users may connect to the map server 180 via a web browser 110 to browse to a user-selectable map and view a display of the map with plotted visual indicia and associated electronic information (email or portion(s) thereof) on it. When the map server 180 sees a request via such a connection, it will prepare a rendering of the map and then search through all the emails that have coordinate strips that relate to the selected map, and then render (i.e. plot) the visual indicia on the map for all those emails that have passed their crystallization controls (e.g. dates). Additional filtering and selection controls and information panes may be provided as discussed above.

FIG. 11 illustrates a diagram with the visual indicium for the “advance” logistical indicator according to the coordinate information of FIG. 3 plotted on the associated diagram element. It is to be understood that FIG. 1 is provided to first illustrate how a coordinate information strip operates to ultimately make a graphic element for a logistical indicator appear on a map, but this is described before describing the collaboration features so it shows what would happen if there were no effect by collaboration controls. For the discussion of the crystallization control feature FIG. 5 is provided to show an example of proposal for changing that logistical indicator from “advance” to “pause” but this is not crystallized so the diagram shown in FIG. 11 also presents a plotting of the visual indicium for the “advance” logistical control. However, if the proposal of FIG. 5 were to crystallize a “pause” visual indicium might, instead appear, subject to other controls.

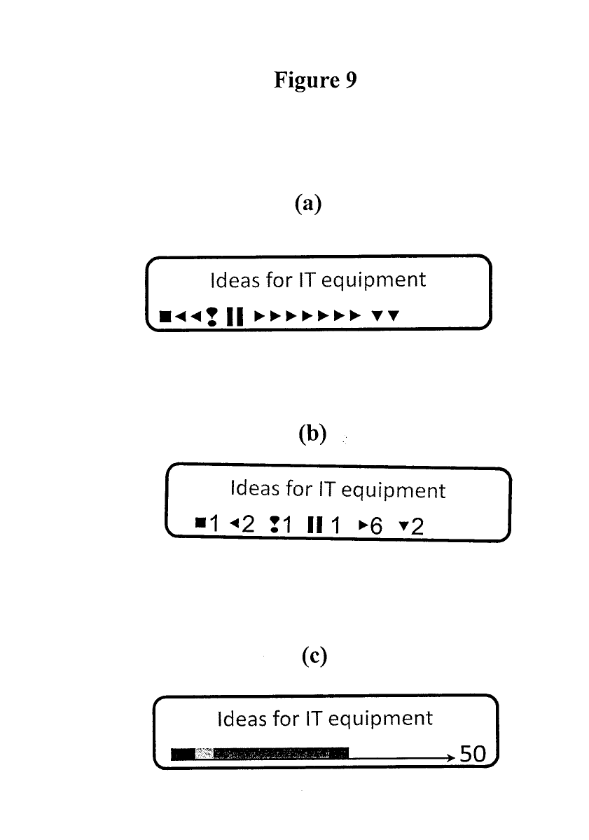

FIG. 8 is a listing, on the left hand side, of exemplary predetermined visual indicia representing user-selectable logistical indicators and, on the right hand side, of the exemplary user-selectable logistical indicators corresponding thereto. FIGS. 9 (a) to (c) illustrates exemplary alternate predetermined visual indicia. As shown by FIG. 9(a) a visual indicium for each contribution may be displayed in serial format or, as shown by FIG. 9(b) a count of like visual indicia may be displayed. Alternatively, the visual representation of the logistical indicators does not have to use discreet graphic elements or symbols. Instead, a continuum of indicia may be displayed as shown by FIG. 9(c) in which the visual indicia are colours, each predetermined visual indicium being a different colour from others, and they are plotting in the form of a bar chart wherein like indicia/colours are grouped together and arranged to display a continuum of colour. The configuration of FIG. 9(c) is appropriate for use when the number of contributions accumulates in a way to overwhelm a rendering using discreet elements. An alternative to using different colours would be to use different patterns or pattern densities. Where such a display continuum is used, a scale number may also be included to help a user to understand absolute numbers.

It should be noted that foregoing invention may also be used in association with electronic information obtained by a user via web surfing. In a collaboration set-up, this would most beneficially occur by pasting the web content into an email, and then the computer-readable media product and method of the invention would operate as described above.

While the invention has been described with reference to an embodiment implemented in a computer network it could, alternatively, be implemented in a single computer for stand-alone use and without the email and collaboration features, for example for management of electronic information obtained from web surfing or other general applications. In this case, there would be no need for separate servers, and the computer program code could be integrated into a single application that resides on a user's PC or other suitable device. For implementation of the invention in this manner, a plug-in may be provided for use with a web browser (or any other suitable program) whereby the computer program code would be executable by the user computer to present a special copy-and-paste operation such that when user-selected electronic information (content) is selected for copy, it can be moved or copied from the computer system clipboard into association with coordinate information and into storage, and upon invocation of a paste operation a coordinate strip dialog element would be presented to the user, as described above with reference to the preferred embodiment, to detail where and how the selected electronic information is to be posted and plotted onto a diagram. The computer program code would be executable by the user computer to store some or all of the electronic information and coordinate information.

Depending upon the specific application of the invention, an alternative rendering of visual indicia/logistical indicators may be used and/or different logistical indicators, than those described above, for example, indicators for money, date, time, location, and/or others.

Embodiments of the invention may be implemented in any conventional computer programming language, as pre-programmed hardware elements, or as a combination of hardware and software components.

A person skilled in the art will readily understand that the invention described herein may be implemented in an alternative embodiment for another application, as desired. Such alternative embodiments or variations are intended to fall within the scope of the invention as defined in the claims that follow.

What is claimed is:

1. Computer-readable media for electronic information management and configured for use with:
(a) a computer program for processing electronic information;
(b) a computer program for displaying a diagram; and,
(c) a diagram store for storing diagram information, the diagram store comprising computer-readable storage media;
wherein the computer-readable media comprises computer program code executable by a computer for:
(d) obtaining from a user diagram information for a diagram, the diagram being associated with a subject and comprising a plurality of interrelated diagram elements representing subject components, the diagram information configured for use by the computer program for displaying to display the diagram;
(e) storing the obtained diagram information in the diagram store;
(f) obtaining from a user coordinate information for a diagram element of a diagram for which diagram information is stored in the diagram store, the coordinate information comprising a user-selectable logistical indicator wherein the logistical indicator is selectable from a plurality of logistical indicators each representing a different a manner of handling the subject component represented by the diagram element and each uniquely represented by a predetermined visual indicium, and wherein the coordinate information, the diagram element and the logistical indicator are associated with electronic information by the user using the computer program for processing electronic information and stored in a store of electronic information accessible to the computer program of the computer-readable media;
(g) storing the coordinate information in a store of coordinate information;
(h) obtaining from the store of diagram information diagram information for a user-selectable diagram;
(i) obtaining from the store of coordinate information coordinate information associated with the diagram elements of the obtained diagram; and,
(j) using the obtained diagram information, the obtained coordinate information and the computer program application for displaying to display the user-selected diagram with the predetermined visual indicium(ia) associated with the logistical indicator(s) of the obtained coordinate information plotted on the displayed diagram in association with the diagram element(s) of the obtained coordinate information, whereby the displayed user-selected diagram with plotted predetermined visual indicium(ia) provides a visual overview of the logistical indicators that have been selected by users and stored in the store of coordinate information for the displayed user-selected diagram.

2. Computer-readable media according to claim 1 wherein the diagrams are of a type selected from a group consisting of a flow chart, map, chart, table and project plan.

3. Computer-readable media according to claim 1 wherein the predetermined visual indicia are graphic elements and each predetermined visual indicium is a different graphic element from the other predetermined visual indicia.

4. Computer-readable media according to claim 1 wherein the predetermined visual indicia are colours, each predetermined visual indicium is a different colour from other predetermined visual indicia and the plotting of the predetermined visual indicium(ia) is in the form of a bar chart wherein like colours are grouped together and colours are arranged as a continuum of colour.

5. Computer-readable media according to claim 1 wherein the computer program for processing electronic information is an electronic mail program and the electronic information is at least a portion of an item of electronic mail.

6. Computer-readable media according to claim 1 wherein the computer program for displaying a diagram is a web browser program.

7. Computer-readable media according to claim 1 configured for use in a computer network comprising at least one server computer, a plurality of user computers and the stores of diagram information, coordinate information and electronic information, wherein at least a portion of the computer program code is executable by each user computer for:
(i) obtaining from a user and providing to the server computer the obtained diagram information;
(ii) obtaining from a user and providing to the server computer the obtained coordinate information;
(iii) using the computer program application for displaying to display the user-selected diagram with the plotted predetermined visual indicium(ia) and to display the at least a portion of the electronic information associated with the logistical indicator represented by the plotted predetermined visual indicium(ia); and,
(iv) using the computer program application for processing electronic information to process the electronic information and provide the processed electronic information to the server computer; and,
wherein at least a portion of the computer program code is executable by the server computer for:
(v) obtaining the diagram information from a user computer;
(vi) obtaining the coordinate information and the electronic information associated with the coordinate information from a user computer; and,
(vii) storing in and retrieving from the stores of diagram information, coordinate information and electronic information the obtained diagram information, coordinate information and electronic information, respectively.

8. Computer-readable media according to claim 7 wherein the at least a portion of the computer program code is executable by each user computer for obtaining from a user in addition to the diagram information user profile information and for providing the user profile information to the server computer, the user profile information defining one or more limitations on user contributions to the coordinate information for the diagram, and wherein at least a portion of the computer program code is executable by the server computer for obtaining the user profile information from the user computer and for storing in and retrieving from a store of user profile information the user profile information for the diagram.

9. A computer-readable media according to claim 8 wherein the obtaining of coordinate information for a diagram from users is controlled according to the user profile information for the diagram.

10. A computer-readable media according to claim 9 wherein the user profile information controls the use of coordinate information in displaying the user-selected diagram.

11. Computer-readable media product according to claim 7 wherein at least a portion of the computer program code is executable by the server computer for: (i) using the obtained diagram information, user profile information and coordinate information for defining for a user computer, for a user-selected diagram, plotted diagram information for the plotting of the predetermined visual indicium(ia) on the user-selected diagram; and, (ii) providing the plotted diagram information to the user computer.

12. Computer-readable media according to claim 1 wherein the plotted predetermined visual indicium may be selectable by the user to display or retrieve at least a portion of the electronic information associated with the logistical indicator represented by that predetermined visual indicium.

13. A method for use by a computer for electronic information management, comprising:
(a) obtaining from a user of the computer diagram information for a diagram, the diagram being associated with a subject and comprising a plurality of inter-related diagram elements representing subject components, the diagram information configured for use to display the diagram;
(b) storing the obtained diagram information in a store of diagram information;
(c) obtaining from a user of the computer coordinate information for a diagram element of a diagram for which diagram information is stored in the diagram store, the coordinate information comprising a user-selectable logistical indicator wherein the logistical indicator is selectable from a plurality of logistical indicators each representing a different a manner of handling the subject component represented by the diagram element and each uniquely represented by a predetermined visual indicium, and wherein the coordinate information, the diagram element and the logistical indicator are associated with electronic information by the computer and stored in a store of electronic information accessible to the computer;
(d) storing the coordinate information in a store of coordinate information;
(e) obtaining from the store of diagram information diagram information for a user-selectable diagram;
(f) obtaining from the store of coordinate information coordinate information associated with the diagram elements of the obtained diagram; and,
(g) using the obtained diagram information, the obtained coordinate information to display the user-selected diagram with the predetermined visual indicium(ia) associated with the logistical indicator(s) of the obtained coordinate information plotted on the displayed diagram in association with the diagram element(s) of the obtained coordinate information, whereby the displayed user-selected diagram with plotted predetermined visual indicium(ia) provides a visual overview of the logistical indicators that have been selected by users and stored in the store of coordinate information for the displayed user-selected diagram.

14. A method according to claim 13 for use by computers of a computer network comprising at least one server computer and a plurality of user computers, the computer network including the stores of diagram information, coordinate information and electronic information, wherein each user computer:
(i) obtains from a user and provides to the server computer the obtained diagram information;
(ii) obtains from a user and provides to the server computer the obtained coordinate information;
(iii) displays the user-selected diagram with the plotted predetermined visual indicium(ia) and the at least a portion of the electronic information associated with the logistical indicator represented by the plotted predetermined visual indicium(ia); and,
(iv) processes the electronic information and provides the electronic information to the server computer; and,
wherein the server computer:
(v) obtains the diagram information from a user computer;
(vi) obtains the coordinate information and the electronic information associated with the coordinate information from a user computer; and,
(vii) stores in and retrieves from the stores of diagram information, coordinate information and electronic information the obtained diagram information, coordinate information and electronic information, respectively.

15. A method according to claim 14 whereby each user computer obtains from a user in addition to the diagram information user profile information and provides the user profile information to the server computer, the user profile information defining one or more limitations on user contributions to the coordinate information for the diagram, and whereby the server computer obtains the user profile information from the user computer and stores in and retrieves from a store of user profile information the user profile information for the diagram.

16. A method according to claim 15 whereby the obtaining of coordinate information for a diagram from users is controlled according to the user profile information for the diagram.

17. A method according to claim 16 whereby the user profile information controls the use of coordinate information in displaying the user-selected diagram.

18. A method according to claim 14 whereby the server computer:
(i) uses the obtained diagram information, user profile information and coordinate information for defining for a user computer, for a user-selected diagram, plotted diagram information for the plotting of the predetermined visual indicium(ia) on the user-selected diagram; and, (ii) provides the plotted diagram information to the user computer.

19. A method according to claim 13 whereby the diagrams are of a type selected from a group consisting of a flow chart, map, chart, table and project plan.

20. A method according to claim 13 whereby the predetermined visual indicia are graphic elements and each predetermined visual indicium is a different graphic element from the other predetermined visual indicia.

21. A method according to claim 13 whereby the predetermined visual indicia are colours, each predetermined visual indicium is a different colour from other predetermined visual indicia and the plotting of the predetermined visual indicium(ia) is in the form of a bar chart wherein like colours are grouped together and colours are arranged as a continuum of colour.

22. A method according to claim 13 whereby the electronic information is at least a portion of an item of electronic mail processed using an electronic mail program.

23. A method according to claim 13 whereby the diagram is display using a web browser program.

24. A method according to claim 13 whereby the plotted predetermined visual indicium may be selectable by the user to display or retrieve at least a portion of the electronic information associated with the logistical indicator represented by that predetermined visual indicium.
